(19) United States
(12) Patent Application Publication
(10) Pub. No.: US 2019/0156013 A1
(43) Pub. Date: May 23, 2019

(54) INFORMATION PROCESSING APPARATUS, INFORMATION PROCESSING METHOD, AND PROGRAM

(71) Applicant: SONY CORPORATION, TOKYO (JP)

(72) Inventors: OSAMU ITO, TOKYO (JP); IKUO YAMANO, TOKYO (JP)

(21) Appl. No.: 16/308,661

(22) PCT Filed: Apr. 5, 2017
(86) PCT No.: PCT/JP2017/014296

§ 371 Date: Dec. 10, 2018

(30) Foreign Application Priority Data
Jun. 27, 2016 (JP) 2016-126580

(51) Int. Cl. G06F 21/36; H04M 1/673; G06F 3/01

(52) U.S. Cl. CPC G06F 21/36; G06F 3/016; H04M 1/673

(57) ABSTRACT

[Object] It is desirable to provide technology capable of reducing the possibility that a third party succeeds in authentication even if the third party steals a glance at the entry of operation information used for authentication. [Solution] Provided is an information processing apparatus including: a presentation control unit configured to control presentation of tactile information to a user; and a determination unit configured to determine whether or not operation information associated with the tactile information is entered from the user.

### TECHNICAL FIELD

The present disclosure relates to an information processing apparatus, an information processing method, and a program.

### BACKGROUND ART

With the rapid spread of a terminal such as smartphones nowadays, in many cases, it is necessary to inhibit the terminal from being operated depending on each user. In one example, there is known a technique for preventing a predetermined operation from being performed in a case where a person other than an authorized user (hereinafter also referred to as “third party”) intends to use a terminal (e.g., refer to Patent Literature 1). Such a technique typically authenticates whether or not a user is authorized on the basis of whether or not the user enters operation information identical to operation information registered in advance by an authorized user (hereinafter also referred to as “valid operation information”).

### CITATION LIST

### Patent Literature

Patent Literature 1: JP 2007-189374A

### DISCLOSURE OF INVENTION

### Technical Problem

In the case where a third party steals a glance at the valid operation information entered by an authorized user, however, there is a possibility that the third party enters the valid operation information on behalf of the authorized user to succeed in authentication illegally. Thus, it is desirable to provide technology capable of reducing the possibility that a third party succeeds in authentication even if the third party steals a glance at the entry of operation information used for authentication.

### Solution to Problem

According to the present disclosure, there is provided an information processing apparatus including: a presentation control unit configured to control presentation of tactile information to a user; and a determination unit configured to determine whether or not operation information associated with the tactile information is entered from the user.

According to the present disclosure, there is provided an information processing method including: controlling presentation of tactile information to a user; and determining, by a processor, whether or not operation information associated with the tactile information is entered from the user.

According to the present disclosure, there is provided a program for causing a computer to function as an information processing apparatus including: a presentation control unit configured to control presentation of tactile information to a user; and a determination unit configured to determine whether or not operation information associated with the tactile information is entered from the user.

### Advantageous Effects of Invention

According to the present disclosure as described above, it is possible to provide technology capable of reducing the possibility that a third party succeeds in authentication even if the third party steals a glance at the entry of operation information used for authentication. Note that the effects described above are not necessarily limitative. With or in the place of the above effects, there may be achieved any one of the effects described in this specification or other effects that may be noticed from this specification.

### BRIEF DESCRIPTION OF DRAWINGS

FIG. 1 is a diagram illustrated to describe typical authentication.

FIG. 2 is a diagram illustrated to describe an overview of an embodiment of the present disclosure.

FIG. 3 is a diagram illustrating an exemplary functional configuration of a terminal.

FIG. 4 is a diagram illustrating an example of association relationship between a tactile pattern, operation information, and an operation image.

FIG. 5 is a diagram illustrating how to enter a first operation element in response to presentation of a first tactile element among tactile patterns.

FIG. 6 is a diagram illustrating how to enter a second operation element in response to presentation of a second tactile element among tactile patterns.

FIG. 7 is a diagram illustrating how to enter a third operation element in response to presentation of a third tactile element among tactile patterns.

FIG. 8 is a diagram illustrating how to enter a fourth operation element in response to presentation of a fourth tactile element among tactile patterns.

FIG. 9 is a flowchart illustrating an example of a registration processing procedure.

FIG. 10 is a diagram illustrating an example of association relationship between tactile information, operation information, and an operation image.

FIG. 11 is a diagram illustrating how to enter a first operation element in response to presentation of a first tactile element in tactile information.

FIG. 12 is a diagram illustrating how to enter a second operation element in response to presentation of a second tactile element in tactile information.

FIG. 13 is a diagram illustrating how to enter a third operation element in response to presentation of a third tactile element in tactile information.

FIG. 14 is a diagram illustrating how to enter a fourth operation element in response to presentation of a fourth tactile element in tactile information.

FIG. 15 is a flowchart illustrating an example of an authentication processing procedure.

FIG. 16 is a diagram illustrating an example of tactile information in which some of a plurality of tactile elements overlap.

FIG. 17 is a diagram illustrating an example in which a plurality of tactile patterns are stored in advance in a storage unit.

FIG. 18 is a block diagram illustrating an exemplary hardware configuration of an information processing apparatus.

### MODE(S) FOR CARRYING OUT THE INVENTION

Hereinafter, (a) preferred embodiment (s) of the present disclosure will be described in detail with reference to the appended drawings. In this specification and the appended drawings, structural elements that have substantially the same function and structure are denoted with the same reference numerals, and repeated explanation of these structural elements is omitted.

Note that, in the present specification and the drawings, structural elements that have substantially the same function and structure are sometimes distinguished from each other using different numbers after the same reference sign. However, when there is no need in particular to distinguish structural elements that have substantially the same function and structure, the same reference sign alone is attached. Further, there are cases in which similar structural elements of different embodiments are distinguished by adding the same reference numeral followed by different letters. However, in a case where it is not necessary to particularly distinguish each of similar structural elements, only the same reference signs are attached.

Moreover, the description will be given in the following order.

### 0. Background

1. Description of embodiment

### 1.1. Overview

1.2. Exemplary functional configuration
1.3. General function
1.4. Registration processing
1.5. Authentication processing
1.6. Various modifications
2. Exemplary hardware configuration
3. Concluding remarks

### 0. BACKGROUND

First, the background of an embodiment of the present disclosure is described. With the rapid spread of a terminal such as smartphones nowadays, in many cases, it is necessary to inhibit the terminal from being operated depending on each user. In one example, there is known a technique for preventing a predetermined operation from being performed in a case where a person other than an authorized user (hereinafter also referred to as “third party”) intends to use a terminal (e.g., refer to JP 2007-189374A). Such a technique typically authenticates whether or not a user is authorized on the basis of whether or not the user enters operation information identical to operation information registered in advance by an authorized user (hereinafter also referred to as “valid operation information”).

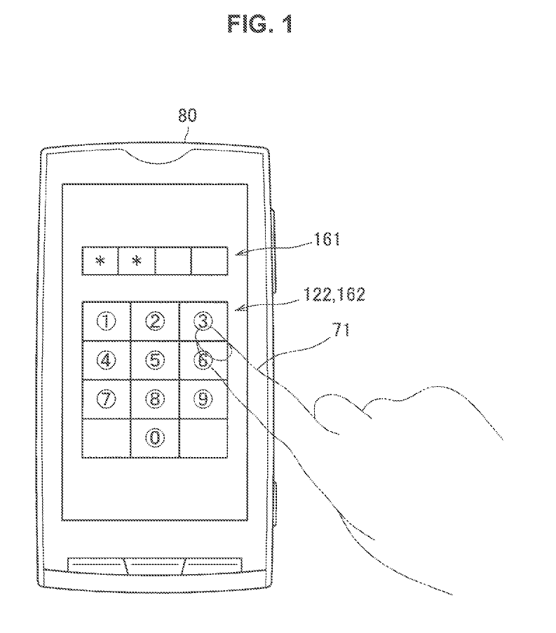

Such typical authentication is described. FIG. 1 is a diagram illustrated to describe typical authentication. As illustrated in FIG. 1, a terminal 80 has an operation element display region 162 that displays information (numbers from “0” to “9” in the example illustrated in FIG. 1) indicating an operation element capable of being entered by a user (more specifically, an operating body part 71 of the user). In addition, the terminal 80 has an operation element detection region 122 capable of detecting operation element entered by the user. The user is able to enter sequentially operation elements to be used for authentication to the operation element detection region 122 while viewing the operation element display region 162.

Furthermore, the terminal 80 has an entry operation display region 161 that sequentially displays information (“*” in the example illustrated in FIG. 1) indicating that the operation element is entered each time the operation element is entered. The user is able to view the entry operation display region 161 to check a numerical character of the entered operation element. Before entry of each operation element, one operation element or a combination of a plurality of operation elements (hereinafter also referred to as “operation information”) is registered in advance. Then, the authentication of whether or not the user is authorized is performed on the basis of whether or not the same operation information as the previously registered operation information is entered by the user.

In the case where a third party steals a glance at the valid operation information entered by an authorized user, however, there is a possibility that the third party enters the valid operation information on behalf of the authorized user to succeed in authentication illegally. Thus, in this specification, description is given mainly on technology capable of reducing the possibility that a third party succeeds in authentication even if the third party steals a glance at the entry of operation information used for authentication.

The background of an embodiment of the present disclosure is described above.

### 1. DESCRIPTION OF EMBODIMENT

An embodiment of the present disclosure is now described.

### [1.1. Overview]

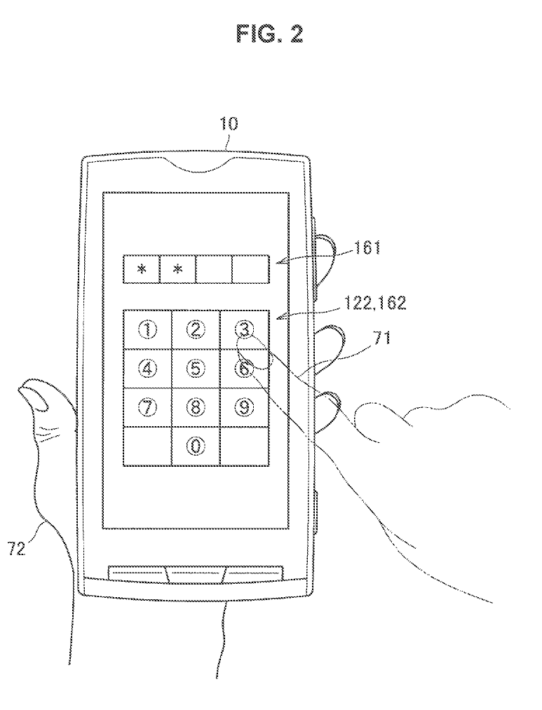

An overview of an embodiment of the present disclosure is now described. FIG. 2 is a diagram illustrated to describe the overview of an embodiment of the present disclosure. As illustrated in FIG. 2, the description herein is given mainly on the assumption that the terminal 10 used by the user is a smartphone. However, the terminal 10 is not limited to a smartphone. In one example, the terminal 10 can be a personal computer (PC), a mobile phone, a clock, or other electronic devices.

As illustrated in FIG. 2, a terminal 10 has an operation element display region 162 that displays information (numbers from “0” to “9” in the example illustrated in FIG. 2) indicating an operation element capable of being entered by a user (more specifically, an operating body part 71 of the user). In addition, the terminal 10 has an operation element detection region 122 capable of detecting operation element entered by the user. The user is able to enter sequentially operation elements to be used for authentication to the operation element detection region 122 while viewing the operation element display region 162.

Furthermore, the terminal 10 has an entry operation display region 161 that sequentially displays information (“*” in the example illustrated in FIG. 2) indicating that the operation element is entered each time the operation element is entered. The user is able to view the entry operation display region 161 to check a numerical character of the entered operation element. The following description is mainly given of a case where the information indicating that the operation element is entered is “*”, but the information indicating that the operation element is entered is not limited to “*”, and it can be other characters. In addition, the information indicating that the operation element is entered is not necessarily displayed.

Further, an embodiment of the present disclosure employs tactile information presented to a user. The description herein is mainly given of the case where a tactile information presentation part 72 is the hand holding the terminal 10. However, the tactile information presentation part 72 can be other parts than the hand of the user's body. In one example, the tactile information presentation part 72 can be the user's arm. In addition, the description herein is mainly given of the case where the tactile information is vibration, but the type of the tactile information is not particularly limited as described later.

The above description is given of the overview of an embodiment of the present disclosure.

### [1.2. Exemplary Functional Configuration]

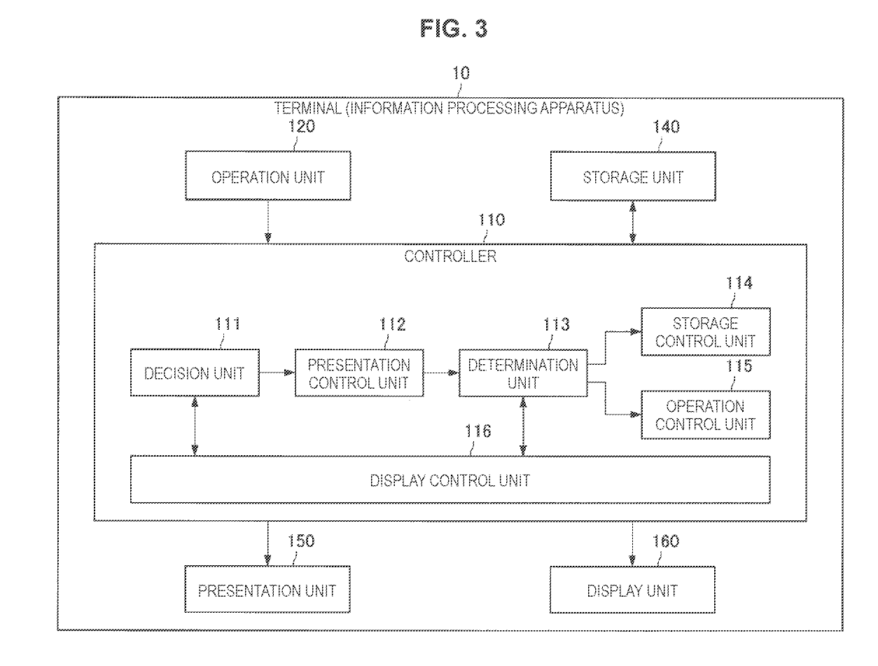

An exemplary functional configuration of a terminal 10 according to an embodiment of the present disclosure (hereinafter also referred to as “information processing apparatus”) is now described. FIG. 3 is a diagram illustrating an exemplary functional configuration of the terminal 10. As illustrated in FIG. 3, the terminal 10 includes a controller 110, an operation unit 120, a storage unit 140, a presentation unit 150, and a display unit 160.

Moreover, the description herein is mainly given of an example in which the controller 110, the operation unit 120, the storage unit 140, the presentation unit 150, and the display unit 160 are located in the same device (terminal 10). However, positions where these functional blocks are located are not particularly limited. In one example, some of these blocks can be located in a server or the like as described later.

The controller 110 controls the entire units of the terminal 10. As illustrated in FIG. 3, the controller 110 includes a decision unit 111, a presentation control unit 112, a determination unit 113, a storage control unit 114, an operation control unit 115, and a display control unit 116. Each of these functional blocks is described later in detail. Moreover, the controller 110 can include, in one example, a central processing unit (CPU) or the like. In a case where the controller 110 includes a processor such as CPU, such a processor can include electronic circuitry.

The operation unit 120 has a sensor and is capable of acquiring a user-entered operation element sensed by the sensor. In one example, the operation unit 120 has the operation element detection region 122 described above. The description herein is mainly given of an example in which the operation unit 120 has a touch panel. In such an example, the operation unit 120 is capable of acquiring, as the operation element, various types of operations detectable by the touch panel, including button press, selection of icons or numeric keys, a single-tap operation, a multiple-tap operation, sequential selection of a plurality of points, a multi-touch operation, a swipe operation, a flick operation, and a pinch operation.

However, the operation unit 120 can include a sensor other than the touch panel. In one example, in a case where the operation unit 120 includes an acceleration sensor, the operation unit 120 preferably acquires, as the operation element, an operation of tilting the terminal 10 or an operation of shaking the terminal 10 on the basis of acceleration detected by the acceleration sensor. Alternatively, in a case where the operation unit 120 includes a gyro sensor, the operation unit 120 preferably acquires, as the operation element, an operation of tilting the terminal 10 or an operation of shaking the terminal 10 on the basis of the angular velocity detected by the gyro sensor. Alternatively, the operation unit 120 can treat non-operation as the operation element. In addition, any combination of these operations can be employed as the operation element.

The storage unit 140 is a recording medium that stores a program to be executed by the controller 110 and stores data necessary for execution of the program. In addition, the storage unit 140 temporarily stores data used for arithmetic operation by the controller 110. The storage unit 140 can be a magnetic storage device, a semiconductor storage device, an optical storage device, or a magneto-optical storage device.

The presentation unit 150 presents tactile information to the user. The description herein is mainly given of the case where the tactile information is vibration. In such a case, the presentation unit 150 preferably has a vibrator that vibrates the terminal 10. However, the type of the tactile information presented to the user is not particularly limited, and can be any type of information as long as the information works on the user's tactile sense but is not sensed by a third party. In one example, the tactile information can be electricity (electrical stimulation), pressing pressure (pressing stimulation), wind pressure (wind pressure stimulation), or warm-cold feeling (thermal sensation).

Further, the presentation unit 150 can treat sound information in a similar way to the tactile information, instead of or in addition to the tactile information. In this event, at least one of sound frequency, sound volume, or sound producing time can be used as the sound information. In addition, a pronunciation rhythm can be used as the sound information, or music obtained by synthesizing a plurality of frequencies can be used as the sound information. In a case where the sound information is presented to the user, the presentation unit 150 preferably generates sound that is not related to the sound information, thereby improving the security.

Further, the presentation unit 150 can treat optical information in a similar way to the tactile information, instead of or in addition to the tactile information. In this event, at least one of wavelength of light, intensity of light, or light emission time can be used as the optical information. In addition, a light-emitting rhythm can be used as the light information. In a case where the optical information is presented to the user, the presentation unit 150 preferably generates light that is not related to the optical information, thereby improving the security.

The display unit 160 displays various kinds of information. In one example, the display unit 160 has the entry operation display region 161 and the operation element display region 162 described above. The display unit 160 can be a display capable of performing display visible to the user, and the display unit 160 can be a projector, a liquid crystal display, or an organic electro-luminescence (EL) display.

The exemplary functional configuration of the terminal 10 according to an embodiment of the present disclosure is described above.

### [1.3. General Function]

The functions of the terminal 10 according to an embodiment of the present disclosure are now described in detail. The presentation control unit 112 controls presentation of the tactile information to the user. Then, the determination unit 113 performs authentication of the user by determining whether or not operation information associated with the tactile information is entered from the user. According to such a configuration, the tactile information is not sensed by a third party, so association relationship between the tactile information and the operation information is not noticed by a third party. Thus, even if a third party steals a glance at the entry of operation information used for authentication, it is possible to reduce the possibility that a third party succeeds in authentication.

The tactile information to be presented to the user is decided by the decision unit 111. In this event, the decision unit 111 decides the tactile information to be presented to the user on the basis of some or all of a plurality of tactile elements stored in advance in the storage unit 140. In a case where the tactile information to be presented to the user is decided on the basis of some of the plurality of tactile elements stored in advance in the storage unit 140, some of the plurality of tactile elements can be different for each user.

The tactile information can be decided randomly or decided on the basis of a predetermined algorithm. In a case where the tactile information is randomly decided, if the association relationship between the tactile information and a pseudo random number is determined in advance, the decision unit 111 can generate a pseudo random number and decide the tactile information on the basis of the generated pseudo random number and the association relationship.

In a case where the tactile information is decided on the basis of a predetermined algorithm, if the association relationship between the tactile information and a predetermined parameter used in the algorithm is determined in advance, the decision unit 111 can decide the tactile information on the basis of the predetermined parameter used in the algorithm and the association relationship. Here, the predetermined parameter used in the algorithm can be any parameter, but a parameter that varies over time is preferable.

In one example, if the positioning of the terminal 10 is possible, the predetermined parameter used for the predetermined algorithm can include the current position of the terminal 10. Alternatively, if the terminal 10 is capable of acquiring the current date, the predetermined parameter used for the predetermined algorithm can include the current date. Alternatively, if the terminal 10 is capable of acquiring the current time, the predetermined parameter used for the predetermined algorithm can include the current time.

Further, in one example, if it is possible to detect the position or movement of the user, the predetermined parameter used for the predetermined algorithm can include the position or movement of the user. In one example, the position of the user can be the position of the user's finger, and the position of the user can be detected by the operation unit 120. In one example, the movement of the user can be the movement of the whole or part of the user's body, or the movement of the user can be detected by the imaging device.

Moreover, the tactile information can be a value that is re-decided every time the authentication is performed, or can be a value that is re-decided for each authentication a plurality of times. In addition, the decision unit 111 can change the complexity of the tactile information to be presented to the user depending on whether or not a person other than the user exists around the terminal 10. In one example, in a case where a person other than the user does not exist around the terminal 10, the decision unit 111 can simplify the tactile information presented to the user, as compared to a case where a person other than the user exists around the terminal 10 (e.g., all the tactile elements included in the tactile information can be made identical), and does not necessarily decide the tactile information (authentication is not necessarily performed).

Here, the judgment of whether or not a person other than the user exists around the terminal 10 can be performed in any way. In one example, in a case where at least one of the time zone in which a person other than the user exists around the terminal 10 (e.g., time zone in which the user is outdoor) or the time zone in which no person other than the user exists around the terminal 10 (time zone in which the user is at home) is registered in advance, the decision unit 111 can judge whether or not a person other than the user exists around the terminal 10 depending on the time zone to which the current time belongs.

Alternatively, in a case where at least one of an area (e.g., outdoor) at which a person other than the user exists around the terminal 10 or an area (e.g., home) at which no person other than the user exists around the terminal 10 is registered in advance, the decision unit 111 can judge whether or not a person other than the user exists around the terminal 10 depending on the area to which the current position of the terminal 10 belongs.

Alternatively, in a case where environmental sound can be detected by a sound sensor, the decision unit 111 can judge whether or not a person other than the user exists around the terminal 10 depending on whether or not the volume of the environmental sound detected by the sound sensor exceeds a threshold value. In this event, the decision unit 111 can identify voice uttered from a person from the environmental sound by identifying the type of sound included in the environmental sound. Then, the decision unit 111 can judge whether or not a person other than the user exists around the terminal 10 depending on whether or not the volume of voice uttered by a person exceeds a threshold value.

Alternatively, in a case where an image can be captured by an imaging device (e.g., front-facing camera), the decision unit 111 can judge whether or not a person other than the user exists around the terminal 10 depending on whether or not a person other than the user is photographed in the image captured by the imaging device. In this event, it is desirable that a person other than the user existing around the terminal 10 is detected as much as possible, so the angle of view of the imaging device can be appropriately adjusted (e.g., the angle of view of the imaging device is preferably set to be large).

The association between the operation information and the tactile information (hereinafter also referred to as “registration processing”) is necessary to be performed before such authentication. In other words, the storage control unit 114 generates association information by associating the plurality of tactile elements stored in the storage unit 140 in advance with the operation elements respectively entered for the plurality of tactile elements. Then, the storage control unit 114 controls the storage unit 140 so that the storage unit 140 may store the generated association information. Such registration processing is described below in detail.

### [1.4. Registration Processing]

As described above, a plurality of tactile elements are stored in the storage unit 140 in advance. Here, a plurality of tactile elements can be stored in any unit. The following description is given of an example in which the plurality of tactile elements are stored for each pattern in which a predetermined first number (four in the following description) of tactile elements are combined (hereinafter also referred to as “tactile pattern”) and the storage control unit 114 generates association information for each tactile pattern. However, each of the plurality of tactile elements can be independently stored. The respective tactile elements included in the tactile patterns are described below in order of presentation thereof.

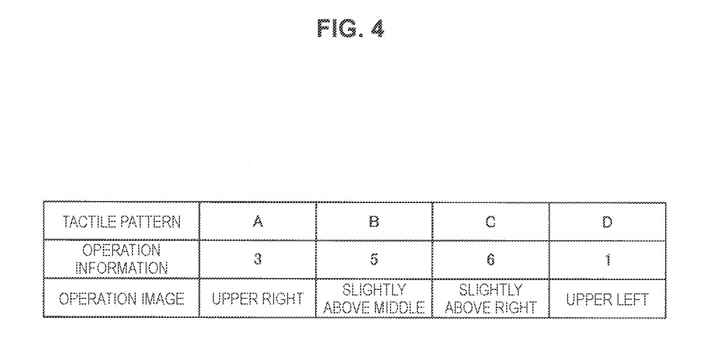

FIG. 4 is a diagram illustrating an example of association relationship between a tactile pattern, operation information, and an operation image. As illustrated in FIG. 4, the tactile pattern (the first tactile element “A”, the second tactile element “B”, the third tactile element “C”, the fourth tactile element “D”) are stored in the storage unit 140 in advance. In addition, the registration processing described in detail later associates the tactile pattern with operation information (an operation element “3” for the first tactile element “A”, an operation element “5” for the second tactile element “B”, an operation element “6” for the third tactile element “C”, and an operation element “1” for the fourth tactile element “D”).

Moreover, in the example illustrated in FIG. 4, the operation element is associated with the tactile element one by one. However, the number of tactile elements and operating elements associated with each other is not limited to a one-to-one relationship. In one example, a plurality of operation elements can be associated with one tactile element. Alternatively, one operation element can be associated with a plurality of tactile elements. Alternatively, a plurality of operation elements can be associated with a plurality of tactile elements. The number of tactile elements and operating elements associated with each other can be determined in advance or is changeable by the user. In addition, in the example illustrated in FIG. 4, different operation elements are associated with different tactile elements, but the same tactile elements can be associated with different tactile elements. In one example, the same operation elements can be associated with the first tactile element “A”, the second tactile element “B”, the third tactile element “C”, and the fourth tactile element “D”.

The user is necessary to remember the operation information entered by the user himself/herself in association with the tactile pattern for when authentication is performed. Here, the user can remember the operation information entered by the user himself/herself in any way. In one example, the user can remember the operation information entered by the user himself/herself depending on information attached to each button (numbers “0” to “9” in the example illustrated in FIG. 2), or can remember the operation information entered by the user himself/herself depending on the operation position (e.g., the position operated on the operation element detection region 122).

In one example, referring to FIG. 2, the button “3” is positioned on the upper right in the operation element detection region 122, the button “5” is positioned slightly above the middle in the operation element detection region 122, the button “6” is positioned slightly above the right in the operation element detection region 122, and the button “1” is positioned on the upper left in the operation element detection region 122. Thus, the user can remember the operation information entered by the user himself/herself in association with the tactile pattern, as shown “operation image” illustrated in FIG. 4 in accordance with these positions.

Moreover, the plurality of tactile elements that are stored in advance in the storage unit 140 have some parameters different from each other and are distinguishable by the parameters. In one example, at least one of a presentation frequency, a presentation amplitude, a presentation interval, a presentation time, a presentation count, or a presentation position of the tactile sense to the user is different, and the plurality of tactile elements stored in advance in the storage unit 140 are distinguishable by the parameter.

The following description is given, as an example, of a case where the presentation positions of the plurality of tactile elements are different from each other and the plurality of tactile elements can be identified depending on the presentation positions. More specifically, the description is given, as an example, of a case where the vibration positions of the tactile element “A”, the tactile element “B”, the tactile element “C”, and the tactile element “D” are different from each other, and the tactile element “A”, the tactile element “B”, tactile element “C”, and tactile element “D” can be identified depending on the vibration positions.

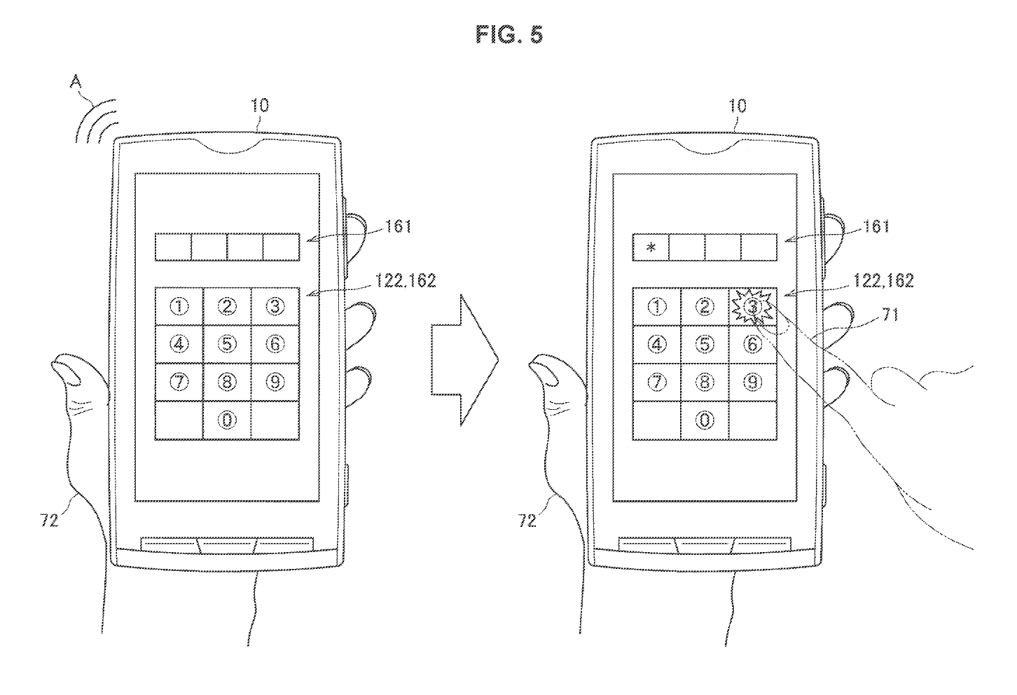

FIG. 5 is a diagram illustrating how to enter the first operation element “3” in response to the presentation of the first tactile element “A” among the tactile patterns. The presentation control unit 112 first controls presentation of the first tactile element “A” among the tactile patterns. FIG. 5 illustrates an example in which the tactile element “A” corresponds to vibration at the upper left of the terminal 10.

The user senses the tactile element “A” using the presentation part 72 and enters the operation element “3” using the operating body part 71 in association with the tactile element “A”. Here, the operation element entered by the user can be optionally determined by the user. The determination unit 113 determines that the operation element “3” is entered to the tactile element “A”, and the display control unit 116 controls the display unit 160 so that “*” is displayed at the first display position of the entry operation display region 161.

The user remembers the association relationship between the tactile element “A” and the operation element “3” entered by the user himself/herself in association with the tactile element “A” for when authentication is performed. In this event, even if a third party steals a glance at the entry of the operation element “3”, the tactile element “A” sensed by the user is not sensed by the third party. This prevents the third party from noticing that the tactile element associated with the operation element “3” is “A”.

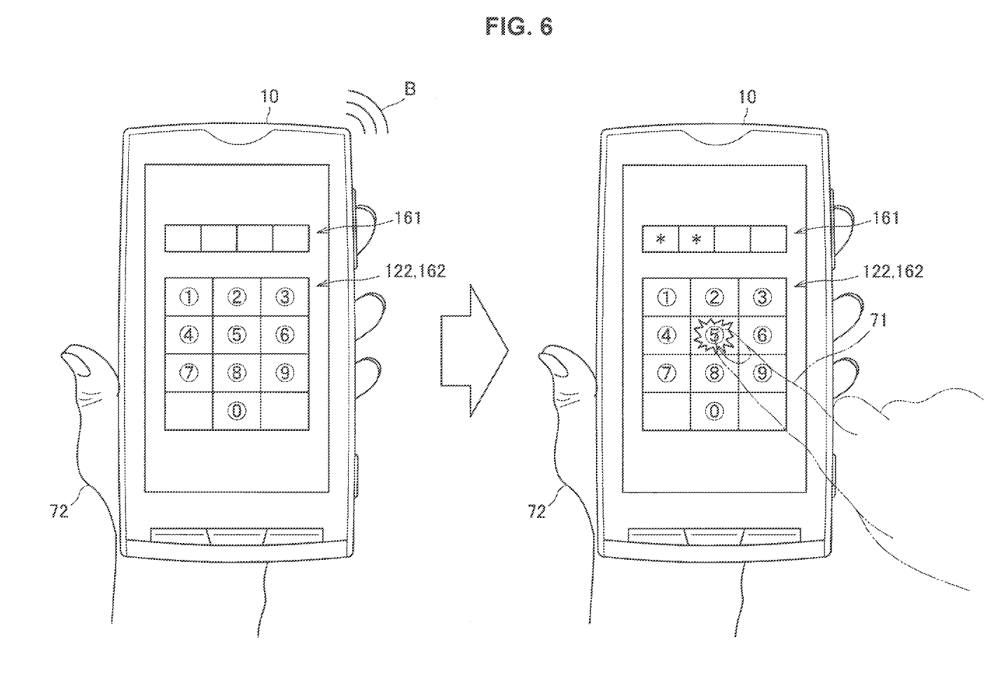

FIG. 6 is a diagram illustrating how to enter the second operation element “5” in response to presentation of the second tactile element “B” among the tactile patterns. Subsequently, the presentation control unit 112 controls presentation of the second tactile element “B” among the tactile patterns. FIG. 6 illustrates, as an example, a case where the tactile element “B” associates with vibration on the upper right of the terminal 10.

The user senses the tactile element “B” using the presentation part 72 and enters the operation element “5” using the operating body part 71 in association with the tactile element “B”. Here, the operation element entered by the user can be optionally determined by the user. The determination unit 113 determines that the operation element “5” is entered to the tactile element “B”, and the display control unit 116 controls the display unit 160 so that “*” is displayed at the second display position of the entry operation display region 161.

The user remembers the association relationship between the tactile element “B” and the operation element “5” entered by the user himself/herself in association with the tactile element “B” for when authentication is performed. In this event, even if a third party steals a glance at the entry of the operation element “5”, the tactile element “B” sensed by the user is not sensed by the third party. This prevents the third party from noticing that the tactile element associated with the operation element “5” is “B”.

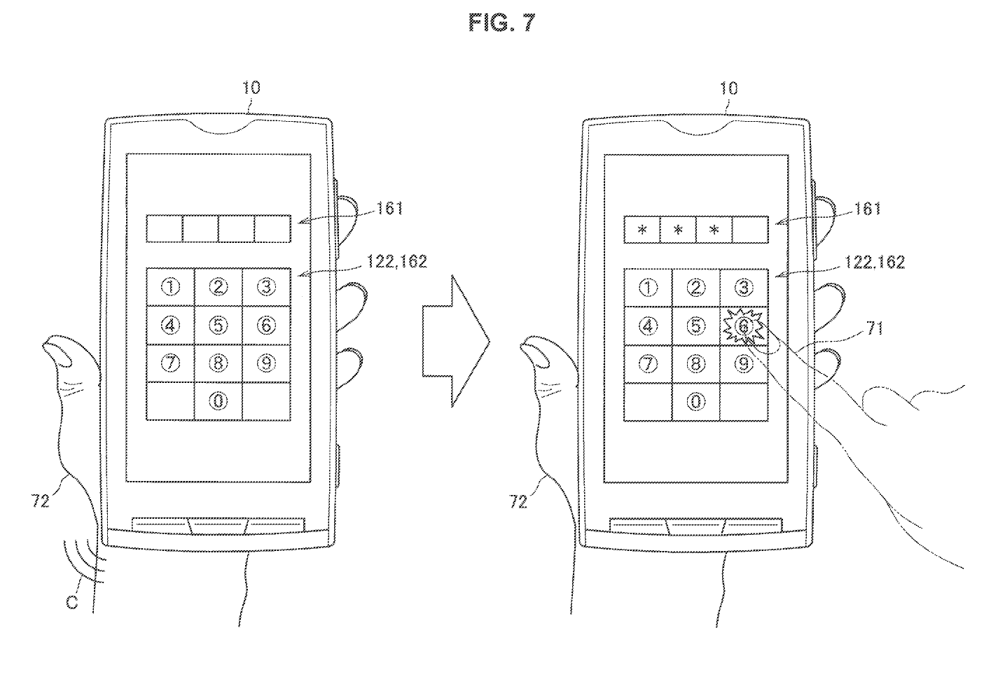

FIG. 7 is a diagram illustrating how to enter the third operation element “6” in response to presentation of the third tactile element “C” among the tactile patterns. Subsequently, the presentation control unit 112 controls presentation of the third tactile element “C” among the tactile patterns. FIG. 7 illustrates, as an example, a case where the tactile element “C” associates with vibration on the lower left of the terminal 10.

The user senses the tactile element “C” using the presentation part 72 and enters the operation element “6” using the operating body part 71 in association with the tactile element “C”. Here, the operation element entered by the user can be optionally determined by the user. The determination unit 113 determines that the operation element “6” is entered to the tactile element “C”, and the display control unit 116 controls the display unit 160 so that “*” is displayed at the third display position of the entry operation display region 161.

The user remembers the association relationship between the tactile element “C” and the operation element “6” entered by the user himself/herself in association with the tactile element “C” for when authentication is performed. In this event, even if a third party steals a glance at the entry of the operation element “6”, the tactile element “C” sensed by the user is not sensed by the third party. This prevents the third party from noticing that the tactile element associated with the operation element “6” is “C”.

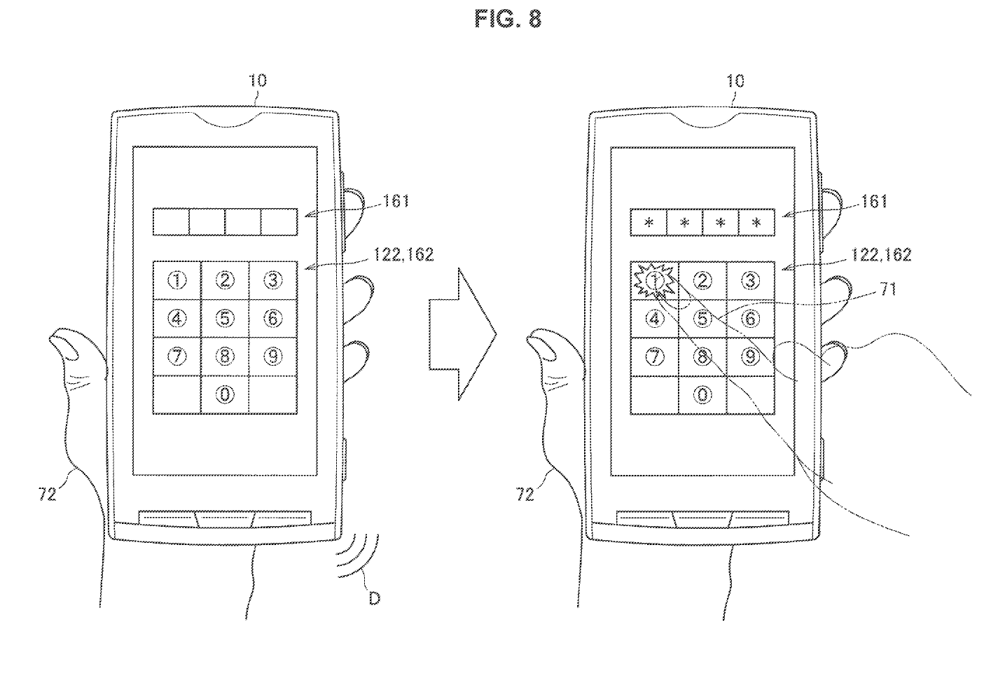

FIG. 8 is a diagram illustrating how to enter the fourth operation element “1” in response to presentation of the fourth tactile element “D” among the tactile patterns. Subsequently, the presentation control unit 112 controls presentation of the fourth tactile element “D” among the tactile patterns. FIG. 8 illustrates, as an example, a case where the tactile element “D” associates with vibration on the lower right of the terminal 10.

The user senses the tactile element “D” using the presentation part 72 and enters the operation element “1” using the operating body part 71 in association with the tactile element “D”. Here, the operation element entered by the user can be optionally determined by the user. The determination unit 113 determines that the operation element “1” is entered to the tactile element “D”, and the display control unit 116 controls the display unit 160 so that “*” is displayed at the fourth display position of the entry operation display region 161.

The user remembers the association relationship between the tactile element “D” and the operation element “1” entered by the user himself/herself in association with the tactile element “D” for when authentication is performed. In this event, even if a third party steals a glance at the entry of the operation element “1”, the tactile element “D” sensed by the user is not sensed by the third party. This prevents the third party from noticing that the tactile element associated with the operation element “1” is “D”.

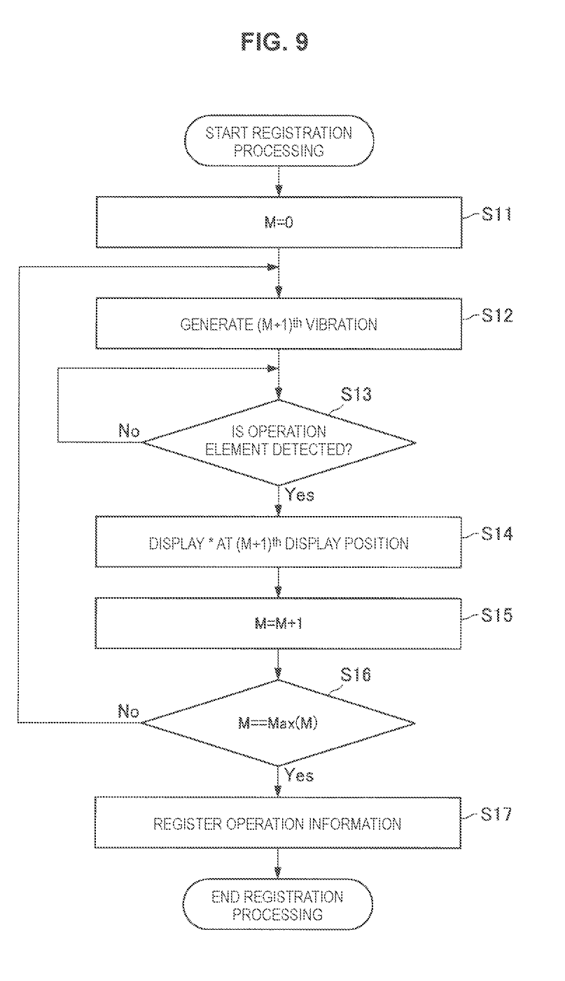

An example of the registration processing procedure is now described. FIG. 9 is a flowchart illustrating an example of the registration processing procedure. Moreover, the flowchart illustrated in FIG. 9 merely shows an example of the registration processing procedure. Thus, the registration processing procedure is not limited to the example shown in this flowchart. As illustrated in FIG. 9, the controller 110 first sets a variable M used to count the number of tactile elements in the tactile pattern to “0” (S11). Subsequently, the presentation control unit 112 generates vibration corresponding to the (M+1)^{th} tactile element among the tactile patterns (S12).

Then, the determination unit 113 determines whether or not an operation element associated with the (M+1)^{th} tactile element is detected (S13). In a case where an operation element associated with the (M+1)^{th} tactile element is not detected (“No” in S13), the determination unit 113 moves the operation to S13. On the other hand, in a case where an operation element associated with the (M+1)^{th} tactile element is detected (“Yes” in S13), the determination unit 113 moves the operation to S14.

Then, the display control unit 116 controls the display unit 160 so that “*” is displayed at the (M+1)^{th} display position in the entry operation display region 161 (S14). The controller 110 increments the value of the variable M by 1 (S15) and determines whether or not the value of the variable M reaches the maximum value (the number of tactile elements included in the tactile pattern) that can be assigned to the variable M (S16).

In a case where the value of the variable M does not reach the maximum value that can be assigned to the variable M (“No” in S16), the controller 110 moves the operation to S12. On the other hand, in a case where the value of the variable M reaches the maximum value that can be assigned to the variable M (“Yes” in S16), the storage control unit 114 registers a combination of operation elements entered in association with each of the M tactile elements in the storage unit 140 as the operation information (S17).

The example of the registration processing procedure is described above. After the registration processing is performed as described above, an authorized user who enters the operation information associated with the tactile pattern in the authentication processing is able to make the authentication succeed and to cause the terminal 10 to execute a predetermined operation (hereinafter referred to as “normal operation”). On the other hand, a third party who fails to enter the operation information associated with the tactile pattern is unable to obtain successful authentication, and is incapable of causing the terminal 10 to execute the normal operation. Such authentication processing is described below in detail.

[1.5. Authentication processing]

When the operation information associated with the tactile pattern stored in advance is entered as described above, as illustrated in FIG. 4, the association relationship between the tactile pattern and the operation information is stored in the storage unit 140 as the association information. In the authentication processing, the decision unit 111 decides tactile information by selecting tactile elements by a predetermined second number (four in the following description) from the tactile pattern. Here, the timing at which the authentication processing is performed is not particularly limited. In one example, the authentication processing can be performed at the time of logging in to operating system (OS) of the terminal 10, or can be performed at the time of logging in to application of the terminal 10.

Moreover, the following description is given of the case where the tactile elements included in the tactile information presented to the user in the authentication processing are equal in number to the tactile elements included in the tactile patterns stored in advance. However, the tactile elements included in the tactile information presented to the user in the authentication processing are not necessarily equal in number to the tactile elements included in the tactile patterns stored in advance. In one example, the number of tactile elements included in the tactile information can be plural or one.

In the authentication processing, the decision unit 111 decides tactile information to be presented to the user. The decision of the tactile information can be performed in any way. In other words, as described above, the tactile information can be randomly decided or can be decided on the basis of a predetermined algorithm. The presentation control unit 112 controls sequential presentation of one or more tactile elements included in the tactile information decided by the decision unit 111. Then, the determination unit 113 determines whether or not an operation element associated with each of one or more tactile elements included in the tactile information is entered by the user.

Moreover, the following description is mainly given of the case where the determination unit 113 collectively determines whether or not an operation element associated with each of one or more tactile elements included in the tactile information is entered by the user after entry of the operation information. In such a case, the entry of the next operation information does not proceed until all the entries of one operation information item is completed, although the security level to a third party is high, in a case where an authorized user erroneously enters an operation information, an unnecessary time occurs until an operation information is entered again. However, if it is possible to accept a command to re-enter the operation information from the beginning or to accept a command to delete the entered operation element, the unnecessary time until the operation information is re-entered by the authorized user is also reduced while maintaining the security level against the third party high.

On the other hand, the determination unit 113 can determines whether or not an operation element associated with each of one or more tactile elements included in the tactile information is entered by the user for each tactile element each time an operation element is entered. In such a case, even if the entry of one operation information item is not completed, it is possible to proceed to the entry of the next operation information, so the security level against the third party is lowered. However, the time until the operation information is re-entered in the case where an authorized user erroneously enters the operation information is reduced.

Then, in a case where the determination unit 113 determines that the user enters the operation information associated with the tactile information, the operation control unit 115 controls execution of the normal operation. On the other hand, in a case where the determination unit 113 determines that the user does not enter the operation information associated with the tactile information, the operation control unit 115 controls execution of a predetermined error operation (prohibits execution of the normal operation). Moreover, the normal operation and the error operation are not particularly limited. In one example, the normal operation can be execution of an application instructed by the user. In addition, the error operation can be display of information indicating authentication failure.

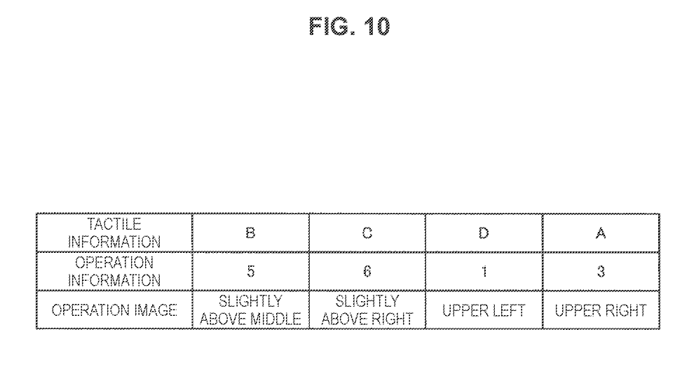

FIG. 10 is a diagram illustrating an example of association relationship between tactile information, operation information, and an operation image. As illustrated in FIG. 10, it is assumed that the decision unit 111 decides the tactile information (the first tactile element “B”, the second tactile element “C”, the third tactile element “D”, and the fourth tactile element “A”) from the tactile patterns registered in advance. Referring to the association relationship between the tactile pattern and the operation information in the registration processing (FIG. 4), the tactile information is associated with the operation information (an operation element “5” for the first tactile element “B”, an operation element “6” for the second tactile element “C”, an operation element “1” for the third tactile element “D”, and an operation element “3” for the fourth tactile element “A”).

The user remembers the association relationship between the tactile pattern and the operation information from the time of the registration processing. Thus, in a case where the tactile information is presented in the authentication processing, the user can enter operation information associated with the tactile information in accordance with the association relationship between the tactile pattern and the operation information, which is remembered in this way. If the user normally enters the operation information associated with the tactile information, the authentication is successful and the normal operation is executed.

Moreover, referring to FIG. 2, the button “5” is positioned slightly above the middle in the operation element detection region 122, the button “6” is positioned slightly above the right in the operation element detection region 122, the button “1” is positioned on the upper left in the operation element detection region 122, and the button “3” is positioned on the upper right in the operation element detection region 122. Thus, the user can enter the operation information for the tactile information in accordance with these positions as shown in the “operation image” illustrated in FIG. 10. The respective tactile elements included in the tactile information are described below in order of presentation thereof.

Moreover, the following description is given of an example in which one operation element is entered after completion of presentation of one tactile element. However, one operation element can be entered before completion of presentation of one tactile element. In addition, the following description is given of an example in which one tactile element is presented to the user only once. However, it is also assumed that the tactile element fails to be recognized by the user by presenting the tactile element only once, so one tactile element can be presented to the user a plurality of times consecutively.

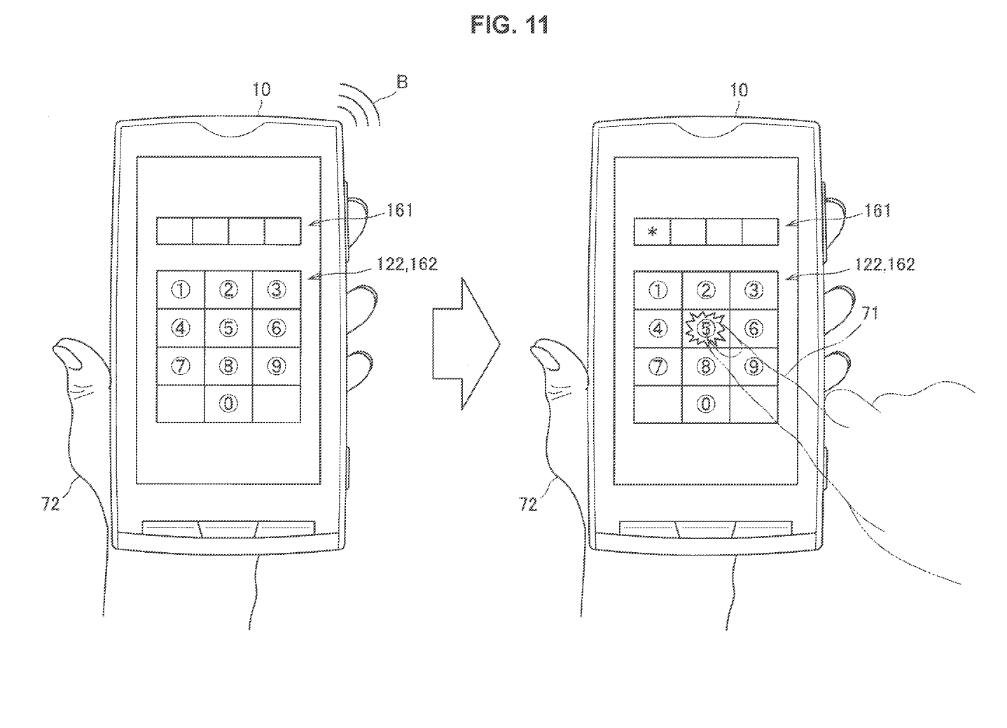

FIG. 11 is a diagram illustrating how to enter the first operation element “5” in response to presentation of the first tactile element “B” among the tactile information items. The presentation control unit 112 first controls presentation of the first tactile element “B” among the tactile information items decided by the decision unit 111. FIG. 11 illustrates a case where the tactile element “B” associates with vibration on the upper right of the terminal 10 as an example, which is similar to the case of performing the registration processing.

The user senses the tactile element “B” using the presentation part 72 and enters the operation element “5” associated with the tactile element “B” using the operating body part 71. The user can remember and enter the operation element associated with the tactile element “B”, which entered by the user himself/herself, in the registration processing. The determination unit 113 determines that the operation element “5” associated with the tactile element “B” is entered, and the display control unit 116 controls the display unit 160 so that “*” is displayed in the first display position of the entry operation display region 161.

Moreover, even if a third party steals a glance at the entry of the operation element “5”, the tactile element “B” sensed by the user is not sensed by the third party. Thus, in the authentication processing, a third party is prevented from noticing that the tactile element associated with the operation element “5” is “B”, which is similar to the registration processing. Thus, even if a third party steals a glance at the entry of the operation element “5”, the third party is incapable of noticing which tactile element is to be entered in association with the operation element “5”, so it is difficult to make authentication successful on behalf of the user.

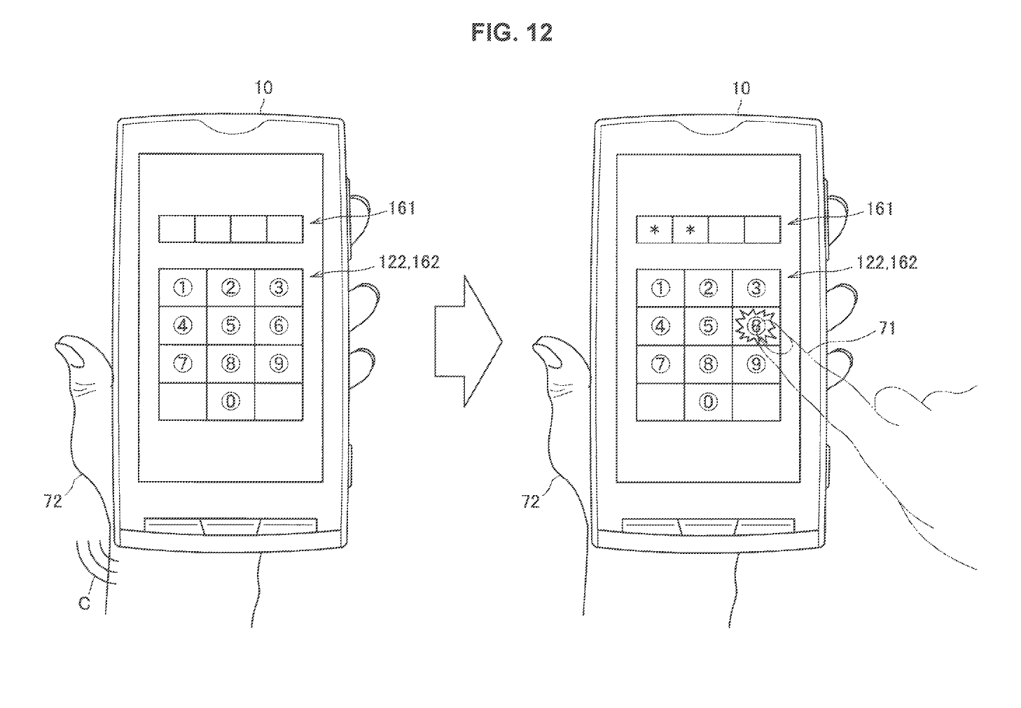

FIG. 12 is a diagram illustrating how to enter the second operation element “6” in response to presentation of the second tactile element “C” among the tactile information items. Subsequently, the presentation control unit 112 controls presentation of the second tactile element “C” among the tactile information items decided by the decision unit 111. FIG. 12 illustrates a case where the tactile element “C” associates with vibration on the lower left of the terminal 10 as an example, which is similar to the case of performing the registration processing.

The user senses the tactile element “C” using the presentation part 72 and enters the operation element “6” associated with the tactile element “C” using the operating body part 71. The user can remember and enter the operation element associated with the tactile element “C”, which entered by the user himself/herself, in the registration processing. The determination unit 113 determines that the operation element “6” associated with the tactile element “C” is entered, and the display control unit 116 controls the display unit 160 so that “*” is displayed in the second display position of the entry operation display region 161.

Moreover, even if a third party steals a glance at the entry of the operation element “6”, the tactile element “C” sensed by the user is not sensed by the third party. Thus, in the authentication processing, a third party is prevented from noticing that the tactile element associated with the operation element “6” is “C”, which is similar to the registration processing. Thus, even if a third party steals a glance at the entry of the operation element “6”, the third party is incapable of noticing which tactile element is to be entered in association with the operation element “6”, so it is difficult to make authentication successful on behalf of the user.

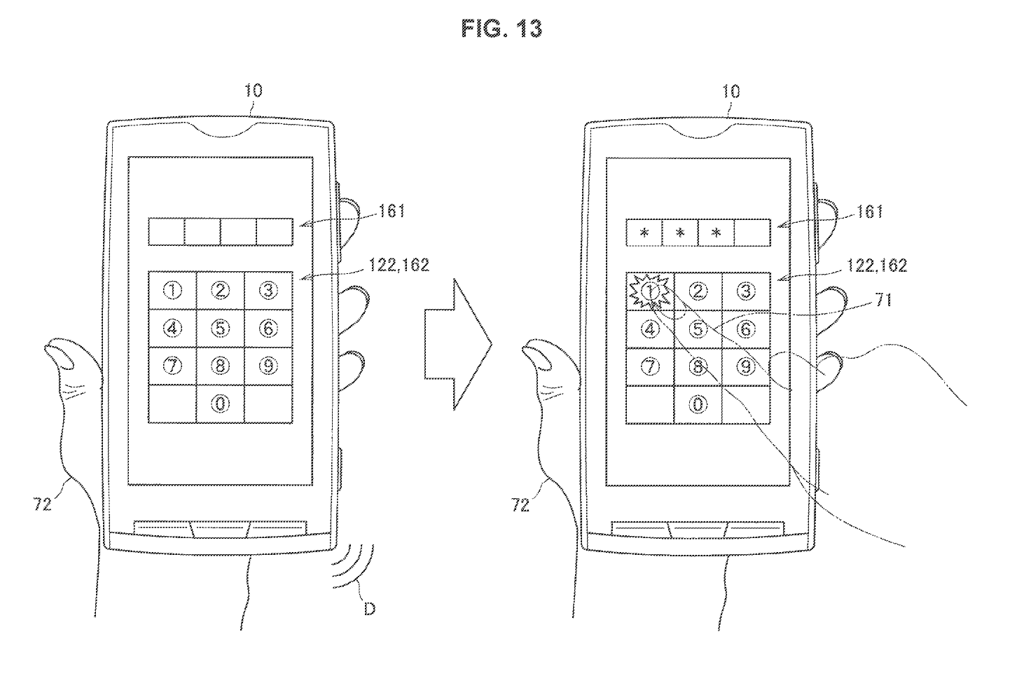

FIG. 13 is a diagram illustrating how to enter the third operation element “1” in response to presentation of the third tactile element “D” among the tactile information items. Subsequently, the presentation control unit 112 controls presentation of the third tactile element “D” among the tactile information items decided by the decision unit 111. FIG. 13 illustrates a case where the tactile element “D” associates with vibration on the lower right of the terminal 10 as an example, which is similar to the case of performing the registration processing.

The user senses the tactile element “D” using the presentation part 72 and enters the operation element “1” associated with the tactile element “D” using the operating body part 71. The user can remember and enter the operation element associated with the tactile element “D”, which entered by the user himself/herself, in the registration processing. The determination unit 113 determines that the operation element “1” associated with the tactile element “D” is entered, and the display control unit 116 controls the display unit 160 so that “*” is displayed in the third display position of the entry operation display region 161.

Moreover, even if a third party steals a glance at the entry of the operation element “1”, the tactile element “D” sensed by the user is not sensed by the third party. Thus, in the authentication processing, a third party is prevented from noticing that the tactile element associated with the operation element “1” is “D”, which is similar to the registration processing. Thus, even if a third party steals a glance at the entry of the operation element “1”, the third party is incapable of noticing which tactile element is to be entered in association with the operation element “1”, so it is difficult to make authentication successful on behalf of the user.

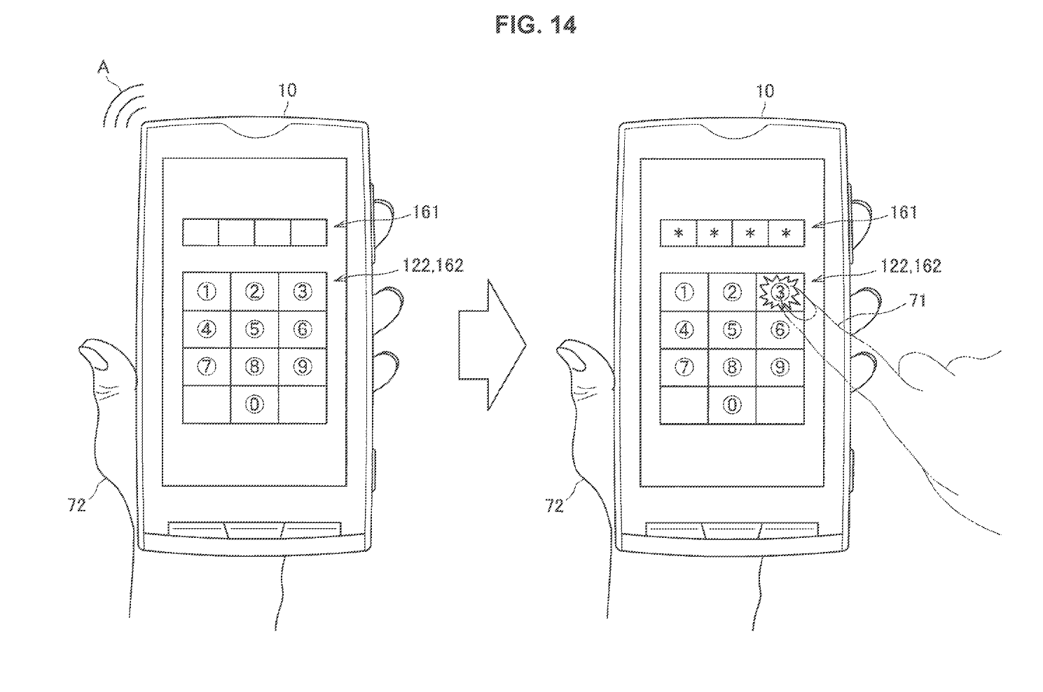

FIG. 14 is a diagram illustrating how to enter the fourth operation element “3” in response to presentation of the fourth tactile element “A” among the tactile information items. Subsequently, the presentation control unit 112 controls presentation of the fourth tactile element “A” among the tactile information items decided by the decision unit 111. FIG. 14 illustrates a case where the tactile element “A” associates with vibration on the upper left of the terminal 10 as an example, which is similar to the case of performing the registration processing.

The user senses the tactile element “A” using the presentation part 72 and enters the operation element “3” associated with the tactile element “A” using the operating body part 71. The user can remember and enter the operation element associated with the tactile element “A”, which entered by the user himself/herself, in the registration processing. The determination unit 113 determines that the operation element “3” associated with the tactile element “A” is entered, and the display control unit 116 controls the display unit 160 so that “*” is displayed in the fourth display position of the entry operation display region 161.

Moreover, even if a third party steals a glance at the entry of the operation element “3”, the tactile element “A” sensed by the user is not sensed by the third party. Thus, in the authentication processing, a third party is prevented from noticing that the tactile element associated with the operation element “3” is “A”, which is similar to the registration processing. Thus, even if a third party steals a glance at the entry of the operation element “3”, the third party is incapable of noticing which tactile element is to be entered in association with the operation element “3”, so it is difficult to make authentication successful on behalf of the user.

In this manner, in a case where the user enters the operation information associated with the tactile information (the operation element “5” for the first tactile element “B”, the operation element “6” for the second tactile element “C”, the operation element “1” for the third tactile element “D”, and the operation element “3” for the fourth tactile element “A”), the determination unit 113 determines that the operation information associated with the tactile information is entered by the user. Then, in a case where the determination unit 113 determines that the user enters the operation information associated with the tactile information, the operation control unit 115 controls execution of the normal operation.

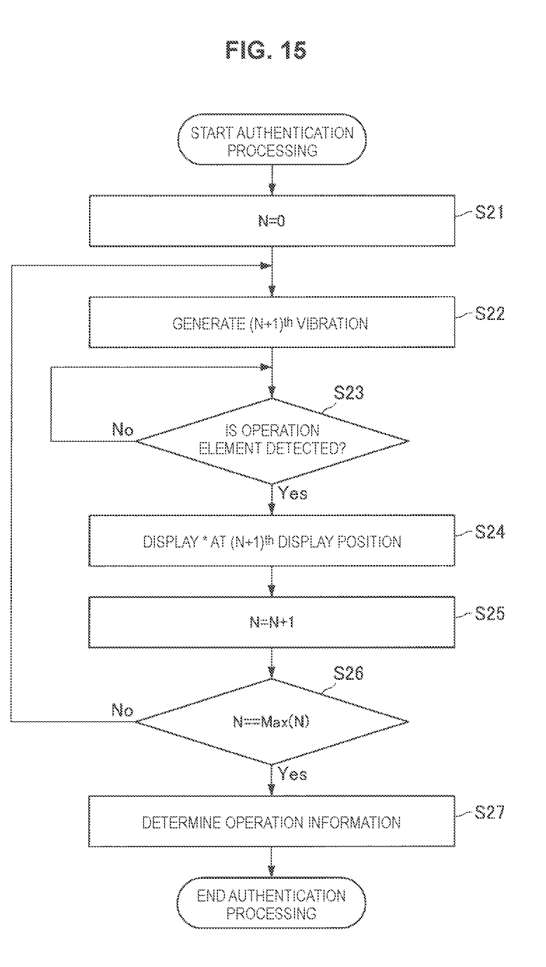

An example of the authentication processing procedure is now described. FIG. 15 is a flowchart illustrating an example of the authentication processing procedure. Moreover, the flowchart illustrated in FIG. 15 merely shows an example of the authentication processing procedure. Thus, the authentication processing procedure is not limited to the example shown in this flowchart. As illustrated in FIG. 15, the controller 110 first sets a variable N used to count the number of tactile elements in the tactile information to “0” (S21). Subsequently, the decision unit 111 decides the tactile information, and the presentation control unit 112 causes vibration corresponding to the (N+1)^{th} tactile element among the tactile information items to be generated (S22).

Then, the determination unit 113 determines whether or not an operation element is detected following the generation of vibration corresponding to the (N+1)^{th} tactile element (S23). In a case where an operation element is not detected following the generation of vibration corresponding to the (N+1)^{th} tactile element (“No” in S23), the determination unit 113 moves the operation to S23. On the other hand, in a case where an operation element is detected following the generation of vibration corresponding to the (N+1)^{th} tactile element (“Yes” in S23), the determination unit 113 moves the operation to S24.

Then, the display control unit 116 controls the display unit 160 so that “*” is displayed at the (N+1)^{th} display position in the entry operation display region 161 (S24). The controller 110 increments the value of the variable N by 1 (S25) and determines whether or not the value of the variable N reaches the maximum value (the number of tactile elements included in the tactile information) that can be assigned to the variable N (S26).

In a case where the value of the variable N does not reach the maximum value that can be assigned to the variable N (“No” in S26), the controller 110 moves the operation to S22. On the other hand, in a case where the value of the variable N reaches the maximum value that can be assigned to the variable N (“Yes” in S26), the storage control unit 114 sets the combination of the operation elements entered in association with each of the N tactile elements as the operation information, and determines whether or not the operation information associates with the tactile information (S27).

Then, in a case where the determination unit 113 determines that the user enters the operation information associated with the tactile information, the operation control unit 115 controls execution of the normal operation. On the other hand, in a case where the determination unit 113 determines that the user does not enter the operation information associated with the tactile information, the operation control unit 115 controls execution of a predetermined error operation (prohibits execution of the normal operation).

An example of the authentication processing procedure is described above. In the above-described registration processing and authentication processing, the case where the user necessarily enters the operation element for the tactile element is described. However, even when the tactile element is presented to the user, it is also assumed that the operation element is not entered from the user within a predetermined time. In such a case, the presentation control unit 112 can cause the user to enter the operation element even after the elapse of the predetermined time. In other words, in a case where there is a tactile element to which no operation element is entered within a predetermined time, the presentation control unit 112 can control re-presentation of the tactile element.

Alternatively, in a case where the user does not enter an operation element within the predetermined time, the fact that the operation is not performed itself can be treated as an operation element. In other words, in a case where there is a tactile element to which no operation element is entered within the predetermined time, the presentation control unit 112 can treat non-operation for the tactile element as entry of an operation element. This makes it possible to increase the number of operation elements that can be entered, so it is possible to further reduce the possibility that a third party succeeds in authentication on behalf of an authorized user.

In this event, the presentation control unit 112 can deliberately provide a waiting time until a tactile element is presented in association with some tactile elements among a plurality of tactile elements included in the tactile patterns. By doing so, if there is a time during which the user does not enter an operation element, it is difficult for a third party to judge whether the time is treated as non-operation or whether the time is the waiting time until the tactile element is presented. Thus, by providing such waiting time, it is possible to further reduce the possibility that a third party succeeds in authentication on behalf of an authorized user.

[1.6. Various modifications]

Various modifications are now described. The above description is given of the example in which the decision unit 111 decides tactile information by selecting one or more tactile elements without overlapping from the tactile pattern. However, the decision unit 111 can decide the tactile information by selecting in an overlapping manner some or all of one or more tactile elements from the tactile pattern. The overlapping of tactile elements included in the tactile information allows variation of the tactile information to increase, so it is possible to reduce the possibility that a third party succeeds in authentication on behalf of an authorized user.

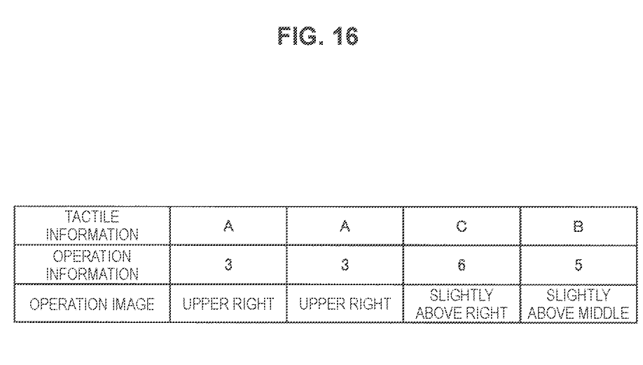

FIG. 16 is a diagram illustrating an example of tactile information in which some of a plurality of tactile elements overlap each other. FIG. 16 illustrates an example of the tactile information decided by the decision unit 111 (the first tactile element “A”, the second tactile element “A”, the third tactile element “C”, and the fourth tactile element “B”). In the tactile information illustrated in FIG. 16, the first tactile element “A” and the second tactile element “A” overlap each other. As in this example, overlapping of tactile elements can be permitted. Moreover, the operation information and operation image associated with the tactile information are as illustrated in FIG. 16.

Further, the above description is given of the example in which one tactile pattern is stored in advance in the storage unit 140 and the decision unit 111 decides tactile information from the one tactile pattern. However, the number of tactile patterns stored in advance in the storage unit 140 is not limited to one. In other words, a plurality of tactile patterns can be stored in advance in the storage unit 140. In this event, the decision unit 111 can decide the tactile information from a plurality of tactile patterns.

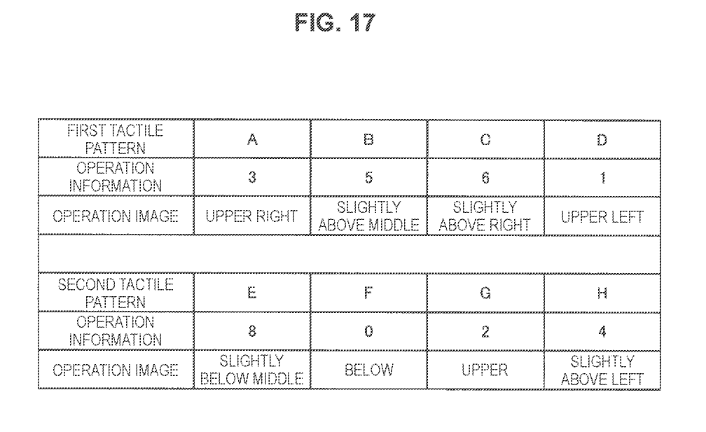

FIG. 17 is a diagram illustrating an example in which a plurality of tactile patterns are stored in advance in the storage unit 140. In the example illustrated in FIG. 17, as an example of a plurality of tactile patterns, a first tactile pattern (the first tactile element “A”, the second tactile element “B”, the third tactile element “C”, and the fourth tactile element “D”) and a second tactile pattern (the first tactile element “E”, the second tactile element “F”, the third tactile element “G”, and the fourth tactile element “H”) are stored in advance in the storage unit 140. Moreover, the operation information and operation image associated with each tactile pattern are as illustrated in FIG. 17.

Here, how to decide tactile information from the first tactile pattern and the second tactile pattern is not particularly limited. In one example, the decision unit 111 can select one tactile pattern from the first tactile pattern and the second tactile pattern, and decide tactile information on the basis of the selected one tactile pattern. Alternatively, the decision unit 111 can decide the tactile information by selecting the same number of tactile elements from the first tactile pattern and the second tactile pattern. Alternatively, in a case where the first tactile pattern to the fourth tactile pattern are stored in advance in the storage unit 140, the decision unit 111 can decide the first tactile element on the basis of the first tactile pattern, decide the second tactile element on the basis of the second tactile pattern, decide the third tactile element on the basis of the third tactile pattern, and decide the fourth tactile element on the basis of the fourth tactile pattern. Moreover, the selection of the tactile pattern and the decision of the tactile information can be performed randomly or performed on the basis of a predetermined algorithm in a manner similar to the above description.

Various modifications are described above.

### 2. EXEMPLARY HARDWARE CONFIGURATION

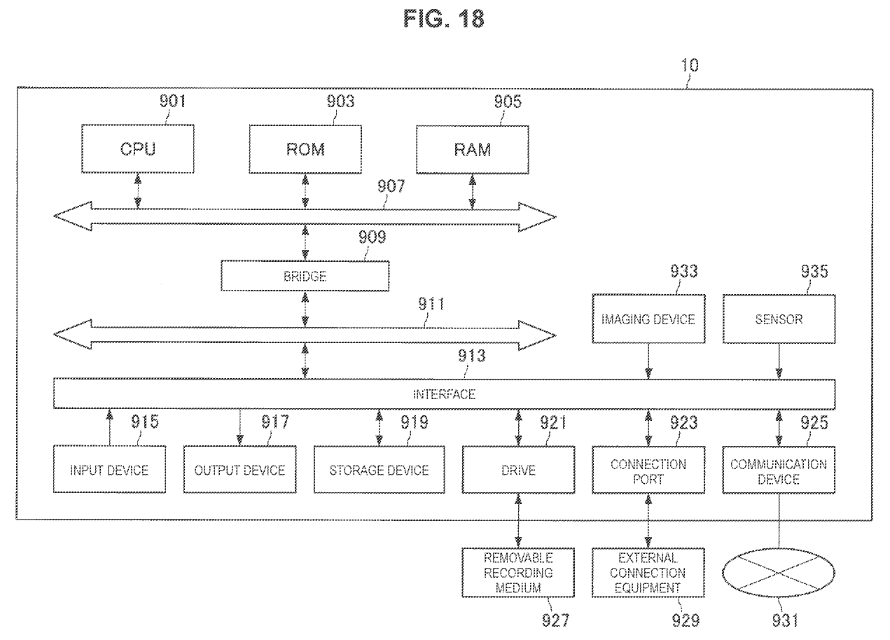

Next, with reference to FIG. 18, a hardware configuration of the information processing apparatus 10 according to the embodiment of the present disclosure will be described. FIG. 18 is a block diagram illustrating the hardware configuration example of the information processing apparatus 10 according to the embodiment of the present disclosure.

As illustrated in FIG. 18, the information processing apparatus 10 includes a central processing unit (CPU) 901, read only memory (ROM) 903, and random access memory (RAM) 905. In addition, the information processing apparatus 10 can include a host bus 907, a bridge 909, an external bus 911, an interface 913, an input device 915, an output device 917, a storage device 919, a drive 921, a connection port 923, and a communication device 925. Moreover, the information processing apparatus 10 can include an imaging device 933 and a sensor 935, as necessary. The information processing apparatus 10 can include processing circuitry such as a digital signal processor (DSP) or an application specific integrated circuit (ASIC), instead of or in addition to the CPU 901.

The CPU 901 functions as an arithmetic processing device and a control device, and controls the overall operation or a part of the operation of the information processing apparatus 10 in accordance with various programs recorded in the ROM 903, the RAM 905, the storage device 919, or a removable recording medium 927. The ROM 903 stores programs, operation parameters, and the like used by the CPU 901. The RAM 905 temporarily stores programs used when the CPU 901 is executed, and parameters that change as appropriate when executing such programs. The CPU 901, the ROM 903, and the RAM 905 are connected with each other via the host bus 907 including an internal bus such as a CPU bus. In addition, the host bus 907 is connected to the external bus 911 such as peripheral component interconnect/interface (PCI) bus via the bridge 909.

The input device 915 is a device operated by a user, such as a mouse, a keyboard, a touchscreen, a button, a switch, and a lever. The input device 915 can include a microphone configured to detect speech of a user. The input device 915 can be a remote control device that uses, in one example, infrared radiation and other types of radio wave. Alternatively, the input device 915 can be external connection equipment 929 such as a mobile phone that corresponds to an operation on the information processing apparatus 10. The input device 915 includes an input control circuit that generates an input signal on the basis of information which is entered by a user to output the generated input signal to the CPU 901. The user operates the input device 915 to input various types of data to the information processing apparatus 10 and to instruct the information processing apparatus 10 to execute a processing operation. In addition, the imaging device 933 to be described later can also function as the input device by capturing movement of the user's hand or the user's finger. In this case, a pointing position can be decided depending on the movement of the hand or a direction of the finger.

The output device 917 includes a device that can visually or audibly report acquired information to a user. Examples of the output device 917 can include a display device such as liquid crystal display (LCD), plasma display panel (PDP), organic electro-luminescence (EL) display, or a projector, a hologram display device, a sound output device such as speaker or headphone, and a printer. The output device 917 outputs a result obtained from the processing performed by the information processing apparatus 10 in the form of video including text and image or sound including speech and acoustic sound. In addition, the output device 917 can include lighting or the like to brighten the surroundings.

The storage device 919 is a device for data storage configured as an example of the storage unit of the information processing apparatus 10. The storage device 919 includes, in one example, a magnetic storage unit device such as hard disk drive (HDD), a semiconductor storage device, an optical storage device, or a magneto-optical storage device. The storage device 919 stores therein various data and programs executed by the CPU 901, and various data acquired from an outside.

The drive 921 is a reader/writer for the removable recording medium 927 such as a magnetic disk, an optical disc, a magneto-optical disk, and a semiconductor memory, and built in or externally attached to the information processing apparatus 10. The drive 921 reads out information recorded on the mounted removable recording medium 927, and outputs the information to the RAM 905. In addition, the drive 921 writes the record into the mounted removable recording medium 927.

The connection port 923 is a port used to directly connect equipment to the information processing apparatus 10. The connection port 923 may be a universal serial bus (USB) port, an IEEE1394 port, and a small computer system interface (SCSI) port, or the like. In addition, the connection port 923 may be an RS-232C port, an optical audio terminal, a high-definition multimedia interface (HDMI, registered trademark) port, and so on. The connection of the external connection equipment 929 to the connection port 923 makes it possible to exchange various kinds of data between the information processing apparatus 10 and the external connection equipment 929.

The communication device 925 is a communication interface including, in one example, a communication device for connection to a communication network 931. The communication device 925 can be a communication card for use of, in one example, wired or wireless local area network (LAN), Bluetooth (registered trademark), or wireless USB (WUSB). The communication device 925 may also be, in one example, a router for optical communication, a router for asymmetric digital subscriber line (ADSL), or a modem for various types of communication. The communication device 925 transmits and receives a signal or the like to and from, in one example, the Internet or other communication devices using a predetermined protocol such as TCP/IP. In addition, the communication network 931 connected to the communication device 925 is a network established through wired or wireless connection. The communication network 931 is, in one example, the Internet, a home LAN, infrared communication, radio communication, satellite communication, or the like.

The imaging device 933 is a device that captures an image of the real space using an image sensor such as a charge-coupled device (CCD) or a complementary metal oxide semiconductor (CMOS) and various members such as a lens for controlling formation of a subject image onto the image sensor, and generates the captured image. The imaging device 933 can be a device that captures a still image or can be a device that captures a moving image.

The sensor 935 is any of various sensors such as a distance sensor, an acceleration sensor, a gyro sensor, a geomagnetic sensor, a vibration sensor, an optical sensor, and a sound sensor. The sensor 935 acquires information regarding the state of the information processing apparatus 10, such as attitude of a housing of the information processing apparatus 10, and acquires information regarding surrounding environment of the information processing apparatus 10, such as brightness and noise around the information processing apparatus 10. In addition, the sensor 935 can include a global positioning system (GPS) sensor that receives GPS signals to measure latitude, longitude, and altitude of the device.

### 3. CONCLUDING REMARKS

As described above, according to the embodiment of the present disclosure, there is provided the information processing apparatus 10 including the presentation control unit 112 that controls presentation of the tactile information to the user and the determination unit 113 that determines whether or not the operation information associated with the tactile information is entered from the user. Such a configuration makes it possible to reduce the possibility that a third party succeeds in authentication even if the third party steals a glance at the entry of operation information used for authentication.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In one example, if the operation of the information processing apparatus 10 described above is implemented, the location of each component is not particularly limited. As a specific example, some or all of respective functional blocks (the decision unit 111, the presentation control unit 112, the determination unit 113, the storage control unit 114, the operation control unit 115, and the display control unit 116) included in the controller 110 can be provided in a server or the like. In this event, the above-described authentication processing can be performed at the time of logging in to web application of the server.

In one example, when the presentation control unit 112 exists in the server, the presentation control of the tactile information by the presentation control unit 112 can include transmission of tactile information from the server to a client. Furthermore, when the display control unit 116 exists in the server, the display control by the display control unit 116 can include transmission of display information from the server to the client. In this way, the information processing apparatus 10 can be implemented by, what we call, cloud computing.

Further, the above description is given of the example in which the presentation unit 150 is incorporated into the information processing apparatus 10, but the presentation unit 150 can be provided outside the information processing apparatus 10. In one example, the above description is given of the example in which the presentation unit 150 presents tactile information to the user's hand holding the information processing apparatus 10. However, the presentation unit 150 can be incorporated into a wristband. In this event, the wristband worn on the user's arm allows the presentation unit 150 incorporated into the wristband to present tactile information to the user's arm. Alternatively, the presentation unit 150 can be incorporated into any wearable device other than the wristband. Examples of the wearable device include a neckband, headphones, eyeglasses, clothes, and shoes.

Further, the above description is mainly given of the case where information indicating entry of the operation element is displayed on the display unit (the case where the display unit 160 has the entry operation display region 161 is mainly described). In addition, the above description is mainly given of the case where the operation element is entered through the touch panel (the case where the operation unit 120 has the operation element display region 162 is mainly described). However, in the case where it is unnecessary to display information indicating entry of the operation element and the case where it is unnecessary to enter the operation element through the touch panel, the information processing apparatus 10 is not necessarily provided with the display unit 160.

Further, the above description is given of the example in which a normal operation is performed in the case where an operation element associated with each of one or more tactile elements included in the tactile information presented to the user is entered without error. However, it is not necessarily possible for the user to accurately enter all of the operation elements depending on the situation in which the user is placed, the ability of the user, and the like. Thus, for some of one or more tactile elements included in the tactile information presented to the user (e.g., about 20% of the entire tactile element), it is acceptable to allow the operation element to be entered erroneously.

In one example, the case where the tactile elements are similar to each other can be considered. Thus, it is not necessarily that the user can recognize similar tactile elements with no error. Accordingly, the degree of tolerance of the error of the operation element entered depending on the similarity between the tactile elements can be changed. In one example, in a case where the similarity between tactile elements exceeds a threshold value, these tactile elements can be allowed to be erroneous in the entered operation element if the entered operation element is closer to the valid operation element to some extent.

Further, the above description is based on the assumption that a tactile element associated with each operation element is presented before entry of each operation element so it takes a certain amount of time until all the operation elements are entered. Thus, other operations can be executed until all the operation elements are entered. In one example, it can be determined whether or not the face of the user captured by an imaging device coincides with the face of the authorized user registered in advance until all the operation elements are entered. Such determination can be additionally used for authentication.

The information processing apparatus 10 according to the embodiment of the present disclosure is applicable to all devices for which authentication is necessary. In one example, the information processing apparatus 10 according to the embodiment of the present disclosure is also applicable to an automatic teller machine (ATM) installed in bank branches, convenience stores, or the like. In this event, a tactile presenting device provided near the screen presents tactile information to a customer, and operation information associated with the tactile information can be entered from the customer by a touch operation on the screen.

In addition, it is also possible to create a program for causing hardware such as CPU, ROM, and RAM that are incorporated into a computer to execute functions equivalent to the functions of the controller 110 described above. Moreover, it is possible to provide a computer-readable recording medium having the program recorded thereon.

Further, the effects described in this specification are merely illustrative or exemplified effects, and are not limitative. That is, with or in the place of the above effects, the technique according to the present disclosure may achieve other effects that are clear to those skilled in the art from the description of this specification.

Additionally, the present technology may also be configured as below.

(1)

An information processing apparatus including:

a presentation control unit configured to control presentation of tactile information to a user; and

a determination unit configured to determine whether or not operation information associated with the tactile information is entered from the user.

(2)

The information processing apparatus according to (1), including

a decision unit configured to decide the tactile information.

(3)

The information processing apparatus according to (2),

in which the decision unit decides the tactile information on a basis of part or all of a plurality of tactile elements stored in advance.

(4)

The information processing apparatus according to (3),

in which the plurality of tactile elements include a plurality of tactile patterns in each of which a predetermined first number of the tactile elements are combined, and

the decision unit decides the tactile information on a basis of one tactile pattern selected from the plurality of tactile patterns.

(5)

The information processing apparatus according to (4),

in which the decision unit decides the tactile information by selecting a predetermined second number of tactile elements from the one tactile pattern.

(6)

The information processing apparatus according to any one of (1) to (5), including

an operation control unit configured to control execution of a predetermined operation in a case where the operation information associated with the tactile information is entered from the user.

(7)

The information processing apparatus according to any one of (1) to (5), including

an operation control unit configured to control execution of a predetermined error operation in a case where the operation information associated with the tactile information is not entered from the user.

(8)

The information processing apparatus according to any one of (1) to (7),

in which the presentation control unit, in a case where a tactile element to which no operation element is entered within a predetermined time exists, controls re-presentation of the tactile element.

(9)

The information processing apparatus according to any one of (1) to (7),

in which the determination unit, in a case where a tactile element to which no operation element is entered within a predetermined time exists, determines that an operation element indicating non-operation is entered to the tactile element.

(10)

The information processing apparatus according to any one of (1) to (9),

in which the presentation control unit controls sequential presentation of one or more tactile elements included in the tactile information, and

the determination unit determines whether or not an operation element associated with each of the one or more tactile elements included in the tactile information is entered from the user.

(11)

The information processing apparatus according to (10),

in which the determination unit collectively determines whether or not an operation element associated with each of the one or more tactile elements included in the tactile information is entered from the user after entry of the operation information.

(12)

The information processing apparatus according to (10),

in which the determination unit determines whether or not an operation element associated with each of the one or more tactile elements included in the tactile information is entered from the user for each tactile element every time the operation element is entered.

(13)

The information processing apparatus according to any one of (1) to (12), including

a display control unit configured to control display of information indicating that an operation element is entered every time the operation element is entered.

(14)

The information processing apparatus according to (3), including

a storage control unit configured to generate association information by associating the plurality of tactile elements with operation elements respectively entered for the plurality of tactile elements and to perform storage control of the association information.

(15)

The information processing apparatus according to (14),

in which the plurality of tactile elements include a plurality of tactile patterns in each of which a predetermined first number of the tactile elements are combined, and

the storage control unit generates the association information for each of the tactile patterns.

(16)

The information processing apparatus according to any one of (1) to (15), in which in the tactile information, at least one of a presentation frequency, a presentation amplitude, a presentation interval, a presentation time, a presentation count, or a presentation position of a tactile sense to the user is different for each tactile element.

(17)

The information processing apparatus according to any one of (1) to (16),

in which the tactile information includes at least one of vibration, electricity, pressing pressure, wind pressure, or warm-cold feeling.

(18)

The information processing apparatus according to any one of (1) to (17),

in which the operation information includes at least one of button press, selection of an icon or a numeric key, a single-tap operation, a multiple-tap operation, sequential selection of a plurality of points, a multi-touch operation, a swipe operation, a flick operation, a pinch operation, an operation of tilting a terminal, an operation of shaking the terminal, or a non-operation.

(19)

An information processing method including:

controlling presentation of tactile information to a user; and

determining, by a processor, whether or not operation information associated with the tactile information is entered from the user.

(20)

A program for causing a computer to function as an information processing apparatus including:

a presentation control unit configured to control presentation of tactile information to a user; and

a determination unit configured to determine whether or not operation information associated with the tactile information is entered from the user.

### REFERENCE SIGNS LIST

10 information processing apparatus (terminal)
71 operating body part
72 presentation part
110 controller
111 decision unit
112 presentation control unit
113 determination unit
114 storage control unit
115 operation control unit
116 display control unit
120 operation unit
122 operation element detection region
140 storage unit

1. An information processing apparatus comprising:
a presentation control unit configured to control presentation of tactile information to a user; and
a determination unit configured to determine whether or not operation information associated with the tactile information is entered from the user.

2. The information processing apparatus according to claim 1, comprising
a decision unit configured to decide the tactile information.

3. The information processing apparatus according to claim 2,
wherein the decision unit decides the tactile information on a basis of part or all of a plurality of tactile elements stored in advance.

4. The information processing apparatus according to claim 3,
wherein the plurality of tactile elements include a plurality of tactile patterns in each of which a predetermined first number of the tactile elements are combined, and
the decision unit decides the tactile information on a basis of one tactile pattern selected from the plurality of tactile patterns.

5. The information processing apparatus according to claim 4,
wherein the decision unit decides the tactile information by selecting a predetermined second number of tactile elements from the one tactile pattern.

6. The information processing apparatus according to claim 1, comprising
an operation control unit configured to control execution of a predetermined operation in a case where the operation information associated with the tactile information is entered from the user.

7. The information processing apparatus according to claim 1, comprising
an operation control unit configured to control execution of a predetermined error operation in a case where the operation information associated with the tactile information is not entered from the user.

8. The information processing apparatus according to claim 1,
wherein the presentation control unit, in a case where a tactile element to which no operation element is entered within a predetermined time exists, controls re-presentation of the tactile element.

9. The information processing apparatus according to claim 1,
wherein the determination unit, in a case where a tactile element to which no operation element is entered within a predetermined time exists, determines that an operation element indicating non-operation is entered to the tactile element.

10. The information processing apparatus according to claim 1,
wherein the presentation control unit controls sequential presentation of one or more tactile elements included in the tactile information, and
the determination unit determines whether or not an operation element associated with each of the one or more tactile elements included in the tactile information is entered from the user.

11. The information processing apparatus according to claim 10,
wherein the determination unit collectively determines whether or not an operation element associated with each of the one or more tactile elements included in the tactile information is entered from the user after entry of the operation information.

12. The information processing apparatus according to claim 10,
wherein the determination unit determines whether or not an operation element associated with each of the one or more tactile elements included in the tactile information is entered from the user for each tactile element every time the operation element is entered.

13. The information processing apparatus according to claim 1, comprising
a display control unit configured to control display of information indicating that an operation element is entered every time the operation element is entered.

14. The information processing apparatus according to claim 3, comprising
a storage control unit configured to generate association information by associating the plurality of tactile elements with operation elements respectively entered for the plurality of tactile elements and to perform storage control of the association information.

15. The information processing apparatus according to claim 14,
wherein the plurality of tactile elements include a plurality of tactile patterns in each of which a predetermined first number of the tactile elements are combined, and
the storage control unit generates the association information for each of the tactile patterns.

16. The information processing apparatus according to claim 1,
wherein in the tactile information, at least one of a presentation frequency, a presentation amplitude, a presentation interval, a presentation time, a presentation count, or a presentation position of a tactile sense to the user is different for each tactile element.

17. The information processing apparatus according to claim 1,
wherein the tactile information includes at least one of vibration, electricity, pressing pressure, wind pressure, or warm-cold feeling.

18. The information processing apparatus according to claim 1,
wherein the operation information includes at least one of button press, selection of an icon or a numeric key, a single-tap operation, a multiple-tap operation, sequential selection of a plurality of points, a multi-touch operation, a swipe operation, a flick operation, a pinch operation, an operation of tilting a terminal, an operation of shaking the terminal, or a non-operation.

19. An information processing method comprising:
controlling presentation of tactile information to a user; and
determining, by a processor, whether or not operation information associated with the tactile information is entered from the user.

20. A program for causing a computer to function as an information processing apparatus comprising:
a presentation control unit configured to control presentation of tactile information to a user; and
a determination unit configured to determine whether or not operation information associated with the tactile information is entered from the user.
